(19) United States
(12) Patent Application Publication
(10) Pub. No.: US 2010/0030668 A1
(43) Pub. Date: Feb. 4, 2010

(54) SYSTEM AND METHOD FOR RETAIL INVENTORY MANAGEMENT

(76) Inventor: John Paben, El Paso, TX (US)

Correspondence Address: MORRISON & FOERSTER LLP, 12531 HIGH BLUFF DRIVE, SUITE 100, SAN DIEGO, CA, 92130-2040, US

(21) Appl. No.: 12/185,586

(22) Filed: Aug. 4, 2008

(51) Int. Cl. G06Q 10/00; G06K 15/00; G06F 17/00

(52) U.S. Cl. 705/28; 235/383; 705/400

(57) ABSTRACT

Methods and systems for managing retail inventory are described, including automatically grading and pricing used or specialty goods (e.g., used clothing) based on market-based criteria. In one example, an employee at a thrift store can receive a shipment of donated used clothes. The employee can sort through each clothing item and enter information for each item, such as brand, type of item, condition, style and other desired information. Based on the information inputted by the employee, the system can accesses a database that stores information about similar items and corresponding market-based parameters, and automatically assign a price or other grading value for the clothing item currently being graded based on a predetermined pricing/grading algorithm. In this manner, a grading or price can be automatically calculated based on statistical market-based criteria. Advantageously, a relatively untrained employee need not have to speculate or guess a price for the used clothing item. Accordingly, exemplary systems can automatically price various types of merchandise based on statistical market-based criteria so that a relatively unskilled employee can sort and assign a price label for each item that more accurately reflects the true value of such an item in the market place.

### FIELD OF THE INVENTION

The present invention relates to a retail management system and, in particular, a system for tracking, grading and pricing used or specialty goods.

### BACKGROUND OF THE INVENTION

Currently, in retail outlets, such as thrift stores, an employee typically prices all items in accordance with unit prices, regardless of brand, condition, quality or style. For example, a designer women's shirt of high quality and condition may be priced the same as a generic women's shirt of low quality. Similarly, a popular article of clothing that is currently in style may be priced the same as a less popular article that is out of style. These types of pricing schemes can result in a loss of revenue to the store, as clothing that is in style should be able to fetch a higher price than clothing that is out of style. On the other hand, clothing that is overpriced may not sell; resulting in further loss of revenue.

Thus, what is needed is a system and method for pricing used or specialty consumer goods according to their current market value. However, in the past, doing so has been inefficient and inaccurate. For example, a skilled worker with knowledge of the present values of goods could be used to examine and price each product. In the event the skilled worker needs to review a wide variety of goods, as can be the case for a thrift store, the skilled worker may need to research similar types of clothing to come up with an appropriate market-based price. This research can take a significant amount of time and result in great inefficiency, particularly if a skilled worker needs to be present at each location of a retail chain. Accordingly, an accurate and efficient pricing method is needed.

### SUMMARY OF THE INVENTION

Exemplary embodiments of the present invention relate to methods and systems for managing merchandise, including automatically grading and pricing used or specialty goods (e.g., used clothing) based on market-based criteria. The system can include software and a database for performing this grading. In one exemplary embodiment, an employee at a thrift store, for example, can receive a shipment of donated used clothes. The employee can sort through each clothing item and enter information for each item, such as brand, type of item (e.g., shirt, pant, etc.), condition (e.g., like new, excellent, worn, poor, etc.), style (e.g., retro, casual, dressy, etc.) and other desired information, including, but not limited to, men's or lady's clothing, size, color, and location of store. Based on the information inputted by the employee, the system can access a database that stores product information about similar items and associated market-based parameters, and automatically assign a price or other grading value for the clothing item currently being graded based on a predetermined pricing/grading algorithm. In this manner, a grading or price can be automatically calculated based on statistical market-based criteria without the user explicitly selecting them. Advantageously, a relatively untrained employee need not have to speculate or guess a price for the used clothing item. Accordingly, exemplary embodiments can automatically price various types of merchandise based on statistical market-based criteria so that a relatively unskilled employee can sort and assign a price for each item that more accurately reflects the true value of such an item in the market place.

Furthermore, exemplary embodiments can generate productivity reports for employees. For example, exemplary embodiments can track the number of items a particular employee has sorted and whether the employee is meeting certain quota expectations (e.g., 100 items per day).

In accordance with various embodiments, a Graphical User Interface (GUI) can be provided that enables a skilled merchandiser (e.g., one with knowledge of pricing the subject merchandise) to enter pricing information based on market factors, such as gender, brand, condition, style, size, store location, and the like, to create a database of pricing information. This pricing database can be continuously updated as new combinations of factors are identified and new types of merchandise are entered into the database.

Once the pricing database is created, unskilled workers (e.g., those with little or no knowledge relating to the pricing of the subject merchandise) can enter market factor information relating to items of merchandise (e.g., used clothing, or other consumer product) and the system can access the database to determine if a price has been set for an item meeting similar criteria. Entry of the information can be performed by manual entry via a keyboard or touchscreen. Optionally, information can also be performed by voice activated command via voice recognition software, for example. If similar criteria for an item have not been previously priced by a skilled merchandiser, then the system can send an alert to an operations center to assign a price corresponding to the combination of criterion. In this way, many items can be assigned market based prices by many unskilled workers. Also, the database can grow as new combinations of criterion are added.

Exemplary embodiments of the present invention can also generate a bar code and price label for each item to track each item from production, inventory to the store floor, when it's sold, its sell-through rate, location sold, etc., thereby allowing monitoring, tracking and management of inventory and pricing of items. In addition, exemplary embodiments can capture the quality, style and sizes sold to allow backfilling of store floor based on consumer demand by item criteria. The bar code and price label can also be used to track each item. Accordingly, exemplary embodiments can notify store personnel when additional inventory is desired, or should be moved from one store to another or price-adjusted, etc. For example, if a large volume of merchandise fitting a certain combination of criteria is selling fast at a particular location, then a merchandiser can determine that the price for such items can be increased at that location, and/or that similar items from one location should be moved to a location where the item is in higher demand.

Exemplary embodiments can also generate reports relating to the merchandise. The reports can relate to inventory levels, price points, what items are selling and not selling, the demand and price elasticity of products, and the profits or retail value of donations (e.g., each 100 lb donation of clothing generates an average retail value of $200), locations and/or other demographics of sales, for example.

Exemplary embodiments can also allow the generation of productivity reports for each employee. For example, reports can indicate how many items a particular employee has sorted/priced and whether the employee is meeting certain quota expectations (e.g., 100 items per day) and can evaluate whether an employee pricing merchandise has different perceptions relating to quality or style than the shopping public or market in general.

### BRIEF DESCRIPTION OF THE DRAWINGS

FIG. 1 illustrates a semi-schematic partial block diagram of a network-based data processing system in accordance with one embodiment of the present invention.

FIG. 2 is a semi-schematic, partial block diagram of a user interface portion of the network-based data processing system of FIG. 1.

FIG. 3 illustrates a more detailed block diagram of the component parts of a user interface suitable for use with the network-based data processing system.

FIG. 4 is a diagram illustrating an example overview of a retail management system according to one embodiment of this invention.

FIG. 5 is a high-level flowchart illustrating operation of a retail management inventorying and pricing system in accordance with one embodiment of the present invention.

FIG. 6 is a generalized general illustration of a store pricing selection screen in accordance with one embodiment of the present invention.

FIG. 7 is a generalized general illustration of a pricing screen for editing and entering price points in accordance with one embodiment of the present invention.

FIG. 8 is a generalized general illustration of a merchandise grading screen in accordance with one embodiment of the present invention.

### DETAILED DESCRIPTION OF THE PREFERRED EMBODIMENT

In the following description of preferred embodiments, reference is made to the accompanying drawings which form a part hereof, and in which it is shown by way of illustration specific embodiments in which the invention may be practiced. It is to be understood that other embodiments may be used and structural changes may be made without departing from the scope of the preferred embodiments of the present invention.

Before describing embodiments of the present invention in detail, it is useful to describe an example environment in which embodiments of the present invention can be implemented. One such example is that of a thrift store chain. From time-to-time, the present invention may be described herein in terms of this example environment. Description in terms of this environment is provided to allow the various features and embodiments of the invention to be portrayed in the context of an exemplary application. However, this disclosure should not be limited to this specific application, but can also be applied in other ways. For example, other applications that fall within the scope of this disclosure include, but not limited to, other types of stores where it is desirable to manage or price inventory, including specialty goods stores, and used or specialty car and boat sales outlets, and the like.

Generally, exemplary embodiments of the present invention can be understood as a systems and methods for managing inventory, including grading, pricing and tracking of inventory in the context of used or specialty goods (e.g., used clothing) based on market-based criteria. In order to enhance the immediacy and breadth of grading and pricing, information can be entered and delivered through a network, such as the World Wide Web (the Internet), which defines a platform allowing information delivery direct to various computer systems. In accordance with various embodiments of the present invention, a retail management system can exist in electronic form, as an application software routine running on a centralized server system, that itself can function as the intermediary between large numbers of users that could be separated geographically from one another. Users can access the grading and pricing exchange from personal computers, whether desktop, laptop or palmtop, using suitable application specific software programs. These programs can be based on Internet standards (HTML, XML and TCP/IP), for example. It should be noted that embodiments of the present invention can also be configured for Wireless Application Protocol-Enabled Software in the particular case where one or more users might wish to maintain communication with the grading and pricing exchange using mobile or wireless service.

To digress momentarily, WAP is an application communication protocol used to access services and information for hand held devices such as mobile phones and PDAs. In order to fit within such small wireless devices, WAP makes use of a micro browser, a truncated set of software that makes minimal demands on hardware, memory and CPU time and is able to display information within a restricted mark-up language termed Wireless Mark-Up Language (WML). It should therefore be understood that the following detailed description of systems and methods in accordance with the invention, is not necessarily limited to desktop, laptop or palmtop-type computer systems, but can be particularly suited for the type of device that an employee might easily carry with them while working in a thrift store or donation receiving station. Users, in a retail management system according to various embodiments, need not be constrained in their normal everyday movements and are not restricted in the other activities which they may wish to undertake.

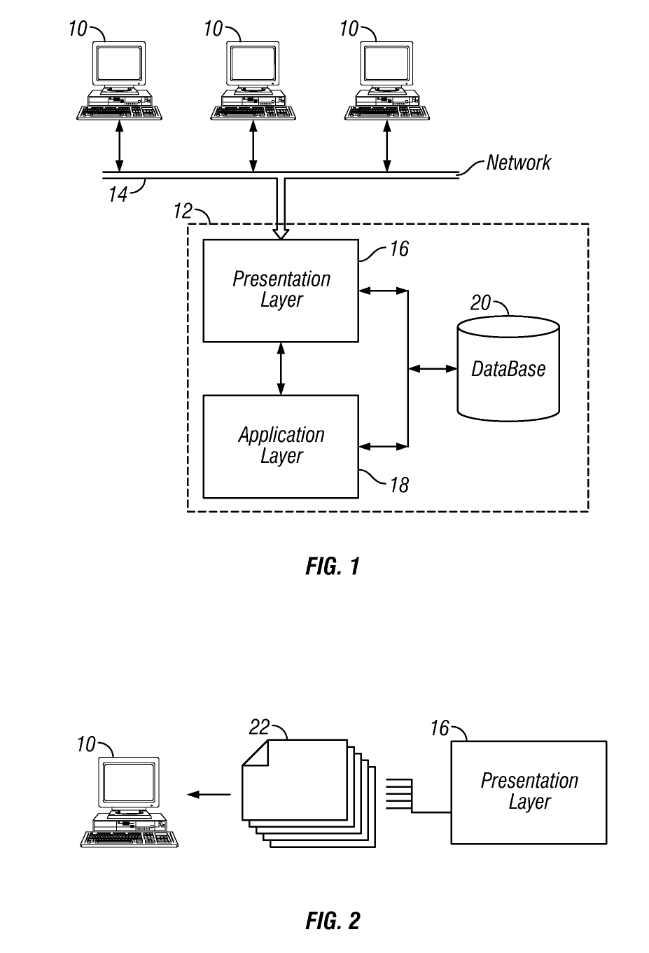

Turning now to FIG. 1, there is shown in semi-schematic partial block diagram form, components of a network-based data processing system, suitable for implementing a retail management system in accordance with an exemplary embodiment. As mentioned previously, the system can be network-based in that a plurality of user terminal devices 10 can be coupled to a central server system 12 by a network communication link 14. The network communication link 14 used to communicate with the server 12 can be implemented in the form of a number of modems which transfer information over public telephone lines, or a cable modem, wireless communication link, or fiber optic line. It should be noted that the specific method by which user terminal devices 10 communicate with the server system 12 is not particularly important in the context of the present invention, so long as the type and scope of information which will be described in greater detail below is able to be transferred between the server system 12 and the user terminal devices 10.

It should also be noted that although only three user terminal devices 10 are depicted in the exemplary embodiment of FIG. 1, those having familiarity with the network systems will understand that thousands, or even more, users can connect to the server system 12 through their respective user terminal devices 10.

Further to FIG. 1, the server system 12 can allow users to track, grade and price goods, as well as to allow for the management of this network as a whole. For example, when an employee enters criteria related to pricing a particular article of merchandise, this information can be transferred from the employee's terminal device to the server system 12 through a presentation layer 16, implemented as a set of user accessible screens having data entry and data delivery fields arranged in such a fashion so as to ease pricing activity. The entered criteria can be processed by an application layer 18, implemented as an application software routine, and which functions, in a manner to be described in greater detail below, as a pricing engine. Application layer 18 processes the inputted information and can post a response, again through the presentation layer 16 to a screen which is accessible by the employee.

In addition to presentation and application layers, the system can further include a database 20 which might be implemented as a monolithic data base, or might also be implemented as a multiplicity of smaller, case-specific databases, for data storage and retrieval. Data base 20 can be particularly suitable for developing and maintaining statistical data regarding pricing and tracking inventory, in addition to storing all the data required by presentation and application layers.

In like manner to the user terminal devices 10, the server 12 is depicted in the exemplary embodiment of FIG. 1, as a single device, but need not be so implemented. The server 12 can be composed of several computing units which might typically contain external storage units, communication interfaces for transferring data between and among users as well as the other servers, processors and memory subsystems and other computing devices that are commonly attached to servers. In addition, a number of servers might be distributed in different geographical locations.

Turning now to FIG. 2, there is illustrated in semi-schematic partial block diagram form, a detail of how the system's presentation layer 16 can interact with a particular user interface terminal device 10. Briefly, the presentation layer 16 can be composed of a number of particular, purpose-built graphic display screens, generally indicated at 22, each of which can be particularly devised to either present or receive application specific data. The presentation layer 16 can also be implemented as a number of graphic screens 22. The graphical display screens 22 can be controlled by a display engine within the presentation layer 16 which can invoke particular display screens depending on individualized choices or access rights of a particular user. Since various embodiments of the present invention can be Internet based, one of the screens, i.e., an entry screen or a top-level screen, can be a retail management home page, from where a user can navigate through the system in an efficient manner. Other pages can be individualized for displaying or receiving pricing specific data, while other pages might be individualized for inventory management purposes, such as tracking sales of a particular type of merchandise or for forming reports.

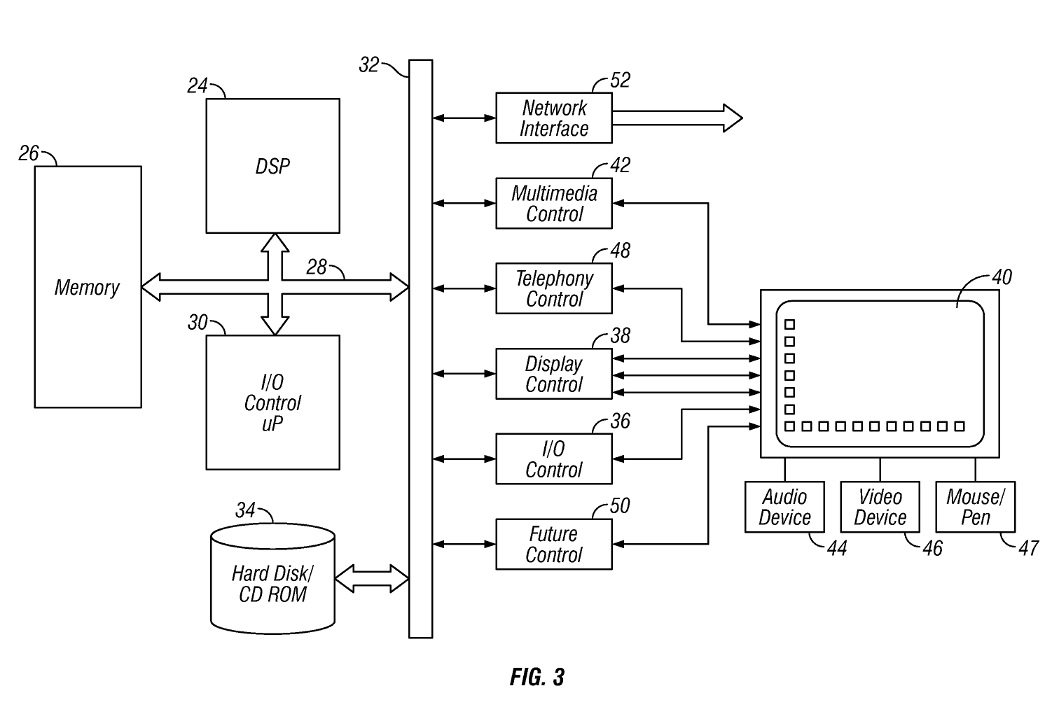

Before discussing the operational details of the embodiments of the present invention, it could be useful to describe the type or types of user interface devices (10 of FIGS. 1 and 2) that can be particularly suited to interface with an exemplary merchandise exchange system. A generalized, block level diagram of such a user interface system is illustrated in FIG. 3 and is illustrated generally at 10. The interface device 10 can be configured as a desktop or laptop-type personal computer system and can be capable of executing an application software routine, such as a net browser program, as well as incorporating various I/O interface devices so as to be able to communicate in accordance with whatever communication link is established between the user device 10 and the exemplary system's server (12 of FIG. 1). The device 10 includes a control processor 24 which might be a digital signal processor, a commercial general purpose microprocessor or a purpose-built processor, capable of executing instructions provided as an application software routine. The system 10 can further include memory 26, such as RAM, ROM, EEPROM, and the like which functions to store the system's operational programming as well as providing temporary storage for data being transferred to and/or from a network server system. The microprocessor 24 and memory 26 can be coupled together over an internal bus 28 which can be further coupled to an I/O control processor 30 which can operate the various interface and peripheral devices which enable the device 10 to communicate with other devices.

Thus, the processor 24 can fetch, decode and execute computer readable instructions and transfer information between other system resources over the main system bus 28 and a peripheral bus 32. Peripheral bus 32 can be interconnected to the various peripheral components in a data processing system and further define the particular protocol for data exchange. An example of such a bus is the Peripheral Component Interconnect (PCI) bus.

A hard disk drive or CD ROM drive 34 can be coupled to the system over peripheral bus 32 and offer the system the capability of large-scale data storage. Access to the hard disk/CD ROM drive 34 can be controlled by an I/O control circuit 36 that directs and controls reading information from and writing information to any of the various storage media that might be implemented within the system. In addition to I/O control 36, the system can further include a display control circuit 38 (i.e., a video card) that determines how information is arranged on a visual display screen 40. A multimedia controller 42 can also be coupled between the peripheral bus 32 and a systems display 40 in order to give the material being presented to a user the added dimensions of sound and motion. In this regard, an audio device, or devices, 44 can be coupled to the system in parallel with the system display 40. The audio device 44 can be implemented as a combination of a microphone and speakers, such that it can receive an audio input from a user through the microphone and deliver audio content to the user over the speakers. A video device 46 can be implemented as a camera which receives moving visual images from the user which can be subsequently processed by the multimedia controller 42 for transmission over the network, for example.

The multimedia controller 42, in combination with a microphone and speaker system comprising the audio device 44 and the camera comprising the video device 46, can provide the system 10 capability of real-time multimedia communication between and among various users of embodiments of the present invention.

Because the system 10 can be implemented as a personal computer (whether desktop, laptop, palm top or the like) it should be evident to those having skill in the art that other interface and/or communication methodologies may be incorporated into the system, on a modular basis, as those communication methodologies are developed and commercialized.

Any or all of the aforementioned communication/interface control devices can be easily coupled to a modem computer system through its peripheral bus 32 as expansion cards or boards. Typically, an expansion card or board can comprise a circuit board hosting integrated circuit chips and other electronic components that adds functionality or resources to a computer system in expandable fashion. For laptop, palmtop and/or other portable computers, expansion cards typically take the form of PC cards, which are credit card-size devices designed to plug into a slot or receptacle provided for such purpose on the side or back of such a computer system. A particular example of such an expansion card is the PCMCIA (Personal Computer Memory Card International Association) card.

In order for the system 10 to communicate with a server or servers implementing embodiments of the present invention, a network interface device 52 can be provided and which is also coupled to the peripheral bus 32. Network interface device 52 can allow the system 10 to communicate with other devices coupled to a particular network in accordance with that particular network's information exchange protocol. For example, the network interface device 52 might be an Ethernet transceiver, or a wireless communication protocol such as Bluetooth, might implemented. Of course, other means permitting user system 10 to access and communicate with a server or servers hosting the merchandise exchange, over some form of local or wide area network, can also used.

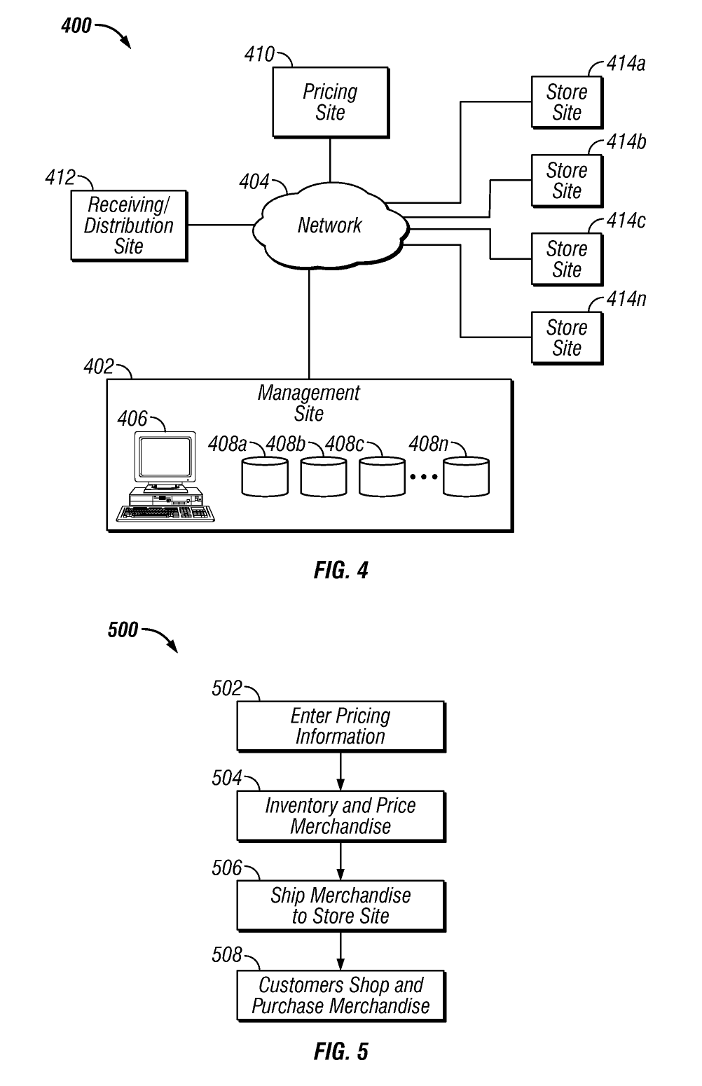

FIG. 4 illustrates an exemplary architecture of a retail management system 400 in accordance with one embodiment of the present invention. Referring to FIG. 4, the merchandise exchange system 400 can include a management site 402 in communicative contact with various other components of the merchandise exchange 400 via a network 404. The network can be the Internet, a local area network, wide area network or the like. In one embodiment, the management site 402 can be implemented to provide centralized management for merchandise pricing, tracking and reporting services, features and functions, including managing one or more databases containing information for facilitating these feature and functions. In alternative embodiments, the services, features and functions provided by the management site 402 as described herein can be distributed across a plurality of various facilities or locations as would be apparent to one of ordinary skill in the art after reading this description.

With further reference to FIG. 4, the exemplary embodiment of management site 402 is illustrated as including one or more computers 406, such as work stations 10 or servers 12 described with reference to FIGS. 1-3, to facilitate operation thereof. Management site 402 can also include one or more databases 408a, 408b, 408c-408n to store the various data and other information used in an order to price, track and monitor the sale and inventory of goods. As described further in examples illustrated below, data content can be maintained and managed relating to pricing, inventory, customer information, sales, inventory movement, employee information and the like. Although separate database units 408a, 408b, 408c-408n are illustrated, data storage can be across any physical or logical data storage architecture, and any of a number of database models can be implemented. In one embodiment, a relational database structure is used to facilitate creation of responses from various separate sources of data.

Management site 402 can be configured to receive information from and provide information to various operational sites to facilitate pricing and tracking goods. Such operational sites can include a pricing site 410 used to price merchandise to market rates; a receiving and distribution site 412 for receiving merchandise, associating the merchandise with a market-based price, and distributing the merchandise to stores; and one or more store sites 414a, 414b, 414c and 414n for selling merchandise to the public.

Further to FIG. 4, the pricing site 412 can serve to price merchandise that is sold in the store sites 414. In accordance with exemplary embodiments, the pricing site 412 can include one or more skilled employees with knowledge about market values concerning the merchandise to be sold. These skilled employees can enter market-based criteria into a database, such as database 408 of the management site 402. Market-based criteria can include any useful information that an employee can use to classify, identify and describe the merchandise. In the context of used clothing, such criteria can include brand, type of item (e.g., shirt, pant, etc.), condition (e.g., like new, excellent, worn, poor, etc.), style (e.g., retro, casual, dressy, etc.) men's or lady's clothing, size, color and the like. It is understood that related types of descriptive information can be used for other types of merchandise outside the context of clothing. As described in more detail below, the market-based criteria can then later be used to accurately and efficiently price or grade merchandise by relatively unskilled workers.

Referring again to FIG. 4, the receiving/distribution site 412 can generally serve as an intake for merchandise. In one exemplary embodiment, the receiving/distribution site 412 can be a center that receives shipments of donated used clothing from various donation drops. One or more employees at the receiving/distribution site 412 can sort through each clothing item and enter descriptive information, such as criteria described above. Based on the information inputted by the employee, the system 400 can accesses the database 408 that stores information about similar items and corresponding market-based parameters, and automatically assign a price or other grading value for the clothing item currently being graded based on a predetermined pricing/grading algorithm. In this manner, a grading or price can be automatically calculated based on statistical market-based criteria. Advantageously, a relatively untrained employee need not have to speculate or guess a price for the used clothing item. Accordingly, exemplary embodiments can automatically price various types of merchandise based on statistical market-based criteria so that a relatively unskilled employee can sort and assign a price label for each item that more accurately reflects the true value of such an item in the market place.

In exemplary embodiments, the receiving/distribution site 412 can also generate a bar code and price label for each item to track each item from inventory to the store floor, when it's sold, its sell-through rate, location sold, etc., thereby allowing monitoring, tracking and management of inventory and pricing of items. In addition, exemplary embodiments can capture the quality, style and sizes sold to allow backfilling of store floor based on consumer demand by item criteria. The bar code and price label can also be used to track each item. Accordingly, exemplary embodiments can notify store personnel when additional inventory is desired, or should be moved from one store to another or price-adjusted, etc. For example, if a large volume of merchandise fitting a certain combination of criteria is selling fast at a particular location, then a merchandiser can determine that the price for such items can be increased at that location, and/or that similar items from one location should be moved to a location where the item is in higher demand.

By tracking merchandise, the system 400 can monitor inventory levels and sales data and generate reports relating to inventory levels, price points, what items are selling and “not” selling, the demand and price elasticity of products, and the profits or retail value of donations (e.g., each 100 lb donation of clothing generates an average retail value of $200), for example.

Receiving/distribution site 412 can also serve to distribute the merchandise to the store sites 414. The merchandise can be distributed by any conventional shipping means, including by mail or truck. In accordance with an embodiment of the present invention, a bill of lading (BOL) can be prepared at the receiving/distribution site 412 containing information about the merchandise being packaged and shipped to a particular store site 414. A copy of the BOL can also be electronically sent to the store site 414. When the store site 414 receives the shipment, an employee at the store site 414 can review the BOL to confirm what was shipped.

Further to FIG. 4, store sites 414 can offer merchandise to the public or private groups. Store sites 414a, 414b, 414c and 414n can be, for example, various geographically distributed retailers, wholesalers or other entities offering merchandise for sell. The store sites 414 can receive shipments of merchandise from the receiving/distribution site 412. As discussed above, the merchandise can include a label attached thereto having a bar code, which can be scanned upon receipt of the merchandise. Scanning the label can automatically cause the store site 414 to send an electronic message to the management site 402 confirming receipt of the merchandise, which can be used for tracking purposes. In addition, scanning the label can automatically place information about the merchandise in the store site's computer system. The bar code on the label can also be scanned when a customer brings the merchandise to a register for the purpose of purchasing the merchandise. This can register the sale of the merchandise in the system 400 and notify the management site 402 that the merchandise was purchased. This purchase information can be used for statistical purposes to account for pricing information and inventory management, for example.

These and other sites of the present invention can be operated by human personnel (such as employees, customers, third-party distributors, contractors) or implemented using hardware, software, firmware, or a combination thereof. Although the sites are described in terms of somewhat discrete functions that may be performed, this description is not intended to imply that physically or logically separate sites need to be provided to perform various of the described functions. Indeed, as would be apparent to one of ordinary skill in the art after reading this description, functions described as associated with the various sites can be assigned to one or more sites, dedicated personnel, hardware or software, or one or more functions can share common sites, personnel, hardware or software. For example, in one embodiment, each of the various sites 402, 410, 412 and 414 may be located in a single building, facility or campus of buildings and communicate with each other via a local area network (LAN) or other suitable communications network or technique.

FIG. 5 is a high level operational flow diagram illustrating an example merchandise pricing process 500 in accordance with an embodiment of the present invention.

In a step 500, an employee can enter pricing information via a pricing screen accessed over the network 404. In accordance with various embodiments, the employee can be skilled in the art of pricing merchandise based on various market-based criteria. To enter pricing information, the employee can log onto a terminal, such as terminal 12, and be presented with a Graphical User Interface (GUI) via the presentation layer 16, as described with reference to FIGS. 1 and 2.

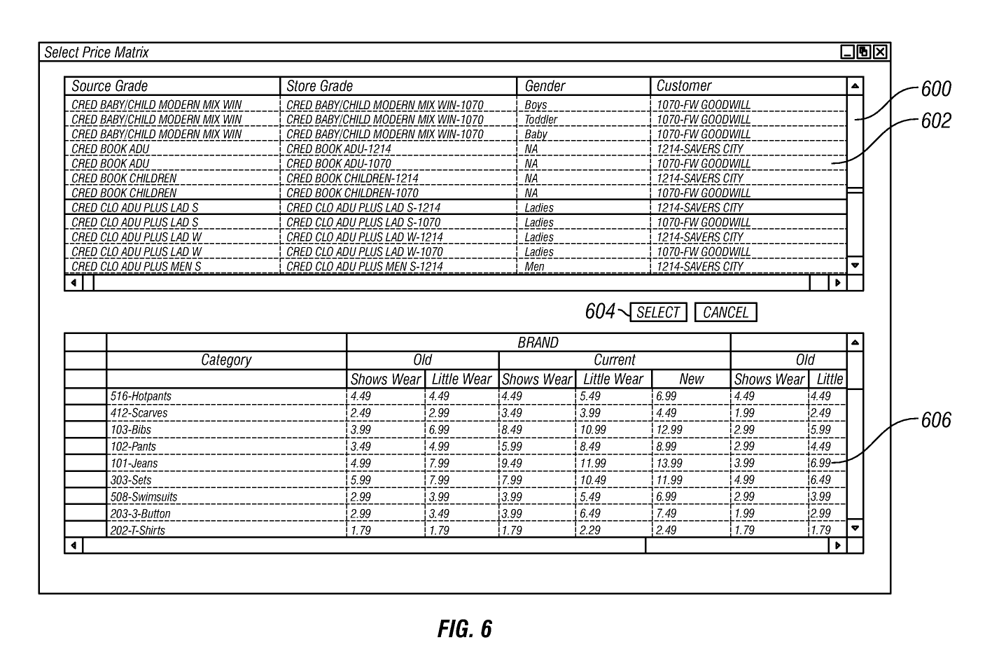

As various embodiments can support pricing for a number of different stores, the employee can first be presented with a selection screen configured to permit the user to select a pricing screen associated with a desired store. Accordingly, to access a pricing screen associated with a particular store, the system 400 can first present the user with a selection screen from which a user can select the desired store. An exemplary selection screen 600 is illustrated in FIG. 6. As illustrated, the selection screen 600 can include a store listing pane 602 displaying a list of stores supported in the system 400. The list can be further broken down by types of merchandise offered by the stores. In other words, in addition to various stores being listed, subsets of information related to merchandise for each store can also be included in the list. For example, a particular store can have a number of entries in the list, such as an entry for women's clothing, men's clothing, children's clothing, and the like. A user can scroll through the list and select a desired entry by highlighting the desired entry and selecting the “select” button 604. In addition, a preview pane 606 can be provided for previewing pricing information associated with a highlighted entry. In this manner, the preview pane 606 can be used to manage items and associated pricing.

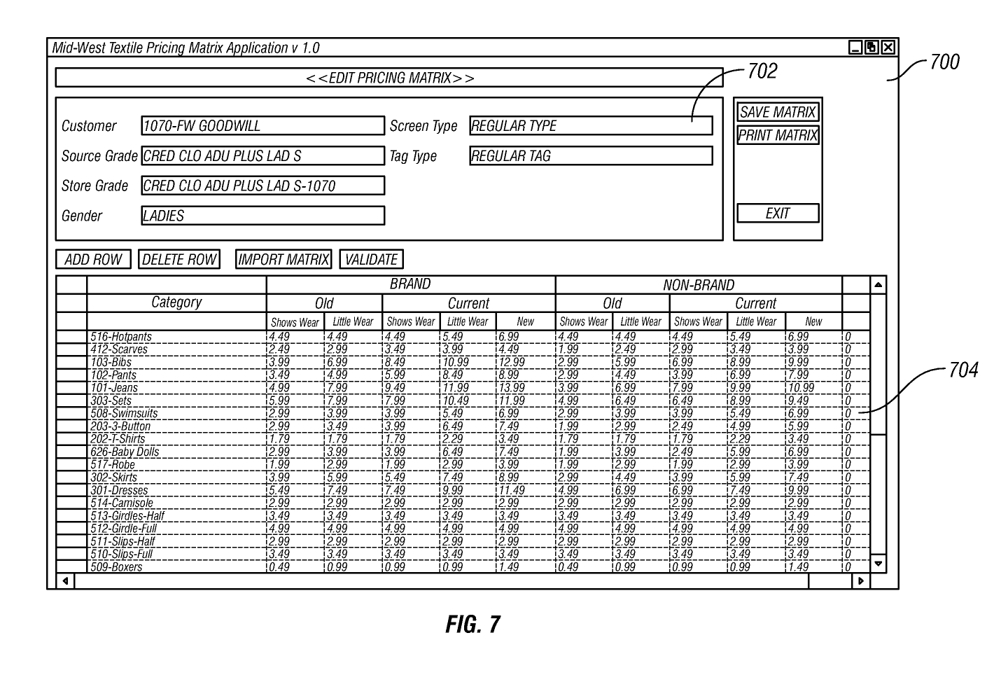

Once a desired store entry is selected, the system 400 can provide the user with its associated pricing screen via the GUI. An exemplary pricing screen 700 is illustrated in FIG. 7. The pricing screen 700 can include a first pane 702 listing the store (or customer) name, a source grade, a store grade, a gender, a screen type and a tag type, for example. A second pane 704 of the pricing screen 700 can include an editable pricing matrix. The pricing matrix can include a category of inventory and associated price points relating to the condition of the category of inventory. For example, the price points can be divided by name brand article or non-brand. The price points can be further sub-divided by the age of the clothing (e.g., old or new) and by perceivable wear (e.g., shows wear, shows little wear or appears new). A user can use the pricing screen 700 to edited previously entered price points and add new categories of inventory and associated price points as needed.

Thus, as described above, forming new pricing and editing existing pricing structures for particular stores can be conveniently accomplished through use of a convenient GUI presented by presentation layer 16 (FIGS. 1 and 2).

Referring back to the pricing process 500 illustrated in FIG. 5, receiving/distribution site 412 can receive merchandise for inventorying and market-based pricing in step 504. For example, in a thrift store environment, donated merchandise can be received at the receiving/distribution site 412 and employees can then go through the merchandise to inventory the merchandise and price the merchandise. To facility inventorying and pricing, each employee can have a computer configured to communicate with management site 402. In one embodiment, the computer can be a hand-held computer device with wireless networking capabilities, so that the employee is free to move about the site 412 and sift through donated merchandise.

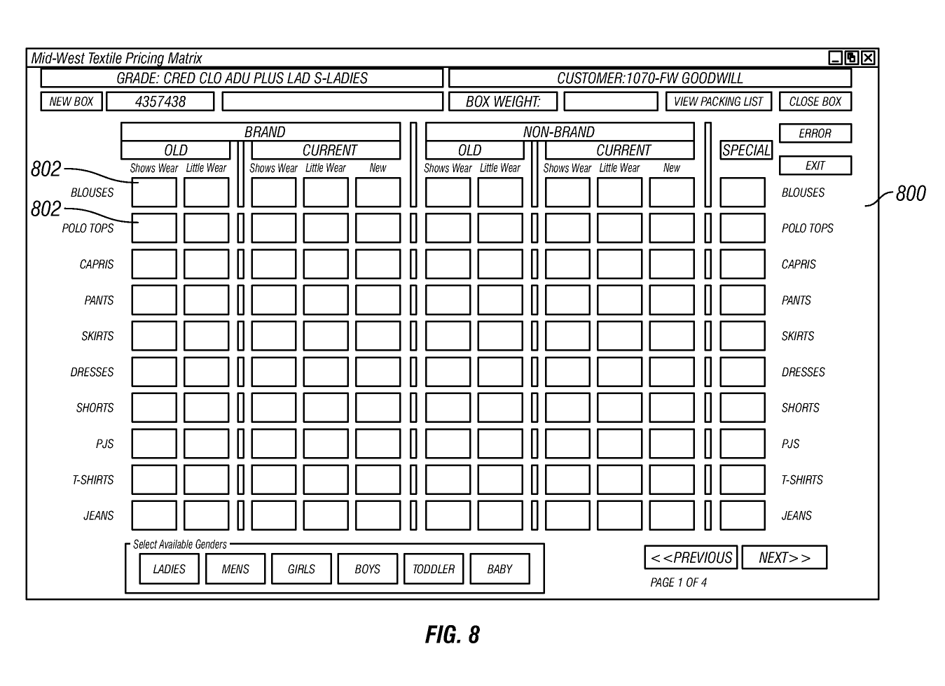

Further to step 504, an employee can be presented with a grading screen displayed on the computer, such as the exemplary grading screen 800 illustrated in FIG. 8. As discussed above, the employee can access the grading screen via the presentation layer 16 discussed with reference to FIG. 1. The grading screen 800 can include a plurality of user selectable buttons 802 corresponding to price points entered in the pricing screen 700. In other words, a user can inventory and price a donated article of merchandise by selecting a button 802 in the grading screen 800 corresponding to predefined criteria. The criteria used in the grading screen 800 can include whether the merchandise is brand or non-brand, whether it is old or current and the amount of wear, for example. It is understood that this criteria is exemplary only, and that any type of market-based pricing criteria can be used.

Accordingly, in the step 504, a user can associate an article of merchandise with an appropriate grading using the grading screen of FIG. 800. Once an article of clothing is graded, an electronic message can be automatically sent to the management site 402 relating the grading information for tracking and inventory allocation purposes.

In the event the article of merchandise is not listed in the grading screen 800, then the employee can notify the pricing site 410 to enter pricing information for the article of merchandise in a manner similar to that described in step 502. For example, in accordance with an exemplary embodiment, an employee can send an electronic message containing information about the article of merchandise to be priced to the pricing site 410, whereupon a skilled employee can review the electronic message and can enter the pricing information via the appropriate pricing screen 700. In one embodiment, the employee can additionally or alternatively send a digital image of the article of merchandise to the pricing site.

Once the user enters a grade for the article of merchandise in step 504, the user's computer can print a label that the user can apply to the merchandise. The label can have an adhesive for affixing the label to the article of clothing. In addition, the label can include pricing information and a bar code, as previously discussed. In addition, a bar code label can be affixed to a package containing one or more articles. The bar code on the package can be used to identify the clothing in the package and associated pricing information of the clothing in the package.

The merchandise can then be shipped to or placed in a customer showroom of a store site 414 in step 506. Concurrently, a BOL, in the form of an electronic communication, can be sent to the store site 414, informing the store site 414 of the contents of the shipment. Once the shipment is received, an employee at the store site 414 can scan the label of each article of merchandise in the shipment or scan a barcode label on a package containing the shipment of clothing. The act of scanning the label can trigger a message to be sent to the management site 402 informing the management site 402 that the article of merchandise was received. In this manner, merchandise can be easily tracked.

Next, in a step 508, a customer can then shop and purchase merchandise at the store site 414. Conveniently, the customer can view pricing information of merchandise printed on an associated label. To purchase an article, the customer can bring the merchandise to a register and an employee can scan the bar code on the label, which can automatically bring up pricing information on the stores register. Once bought, an electronic message can be sent to the management site 402 notifying the management site 402 that the article of merchandise was purchased, as well as any other information associated with the purchase, including the time of purchase, employee that sold the merchandise and the like. This information can be stored at the management site 402 and later processed for analysis and reporting.

As described above, because the merchandise management system 400 can retain many types of information relating to the pricing and sales of merchandise, the management system 400 is capable of producing many useful reports. For example, the system 400 can generate reports relating to inventory levels, price points, what items are selling and not selling, the demand and price elasticity of products, and the profits or retail value of donations, locations and/or other demographics of sales. In addition, exemplary embodiments can also allow the generation of productivity reports for each employee. For example, productivity reports can indicate how many items a particular employee has sorted and whether the employee is meeting certain quota expectations (e.g., 100 items per day) and can evaluate whether the employee pricing merchandise has different perceptions relating to quality or style than the shopping public or market in general.

It should also be noted that there are many alternative ways of implementing the methods and apparatuses of the present invention. It is therefore intended that the following appended claims be interpreted as including all such alterations, permutations, and equivalents as fall within the true spirit and scope of the present invention.

What is claimed is:

1. A data processing system for managing retail inventory, comprising:
an inventory management platform, including a communication network linking a community of participating users, the inventory management platform including a server system coupled to user access devices over the communication network;
a database, the database storing market-based parameters related to pricing various types of merchandise offered for sale one or more store sites operated by at least some of the participating users; and
a pricing engine hosted by the server system, the pricing engine facilitating pricing of items of inventory based on information provided by one or more participating users.

2. The data processing system of claim 1, wherein the type of merchandise includes used merchandise.

3. The data processing system of claim 1, wherein the information provided by the one or more participating users is at least one of a type of an item, a condition of an item, and a brand of an item.

4. The data processing system of claim 3, wherein the database additionally stores inventory management information.

5. The data processing system of claim 4, further including a management engine configured to produce reports based on the inventory management information stored in the database.

6. The data processing system of claim 1, wherein the pricing engine interacts with participating users over a set of user specific presentation screens.

7. The data processing system of claim 6, wherein the presentation screens are accessible through a browser application.

8. The data processing system of claim 1, further comprising an inventory management engine configured to generate a message when additional inventory is desired.

9. The data processing system of claim 1, further comprising an inventory management engine configured to notify participating users when inventory should be price adjusted.

10. A method for pricing an item of merchandise based on market-based criteria, comprising:
receiving and storing pricing points associated with various types of merchandise into a database;
receiving input indicative of a selection of one of a plurality of pricing parameters associated with a particular item to be priced; and
generating a market-based price of the particular item by associating a one of the pricing points with the selected pricing parameter.

11. The method of claim 10, further including displaying each of the plurality of pricing parameters in a graphical user interface, each pricing point displayed in the form of a user selectable button.

12. The method of claim 10, further comprising generating a label containing a bar code and the market-based price.

13. The method of claim 10, wherein, upon receiving the input indicative of a selection of one of the pricing parameters, storing inventory tracking information in the database associated with the item being priced.

14. The method of claim 13, further comprising generating a management report based on inventory management information.

15. The method of claim 13, further comprising generating an employee performance report based on inventory management information.
